(19) United States
(12) Patent Application Publication
(10) Pub. No.: US 2025/0214145 A1
(43) Pub. Date: Jul. 3, 2025

(54) METAL PROCESSING AND FORMING SYSTEM AND METAL PROCESSING AND FORMING METHOD

(71) Applicant: INDUSTRIAL TECHNOLOGY RESEARCH INSTITUTE, Hsinchu (TW)

(72) Inventors: Sheng-Chieh HSU, Hsinchu City (TW); Chien-Yu WU, Hsinchu City (TW); Chin-Chi HSIAO, Taoyuan City (TW); Shu HUANG, Zhudong Township (TW)

(73) Assignee: INDUSTRIAL TECHNOLOGY RESEARCH INSTITUTE, Hsinchu (TW)

(21) Appl. No.: 18/419,201

(22) Filed: Jan. 22, 2024

(30) Foreign Application Priority Data
Jan. 2, 2024 (TW) 113100126

(51) Int. Cl. B22F 12/60; B22F 10/38; B33Y 10/00; B33Y 30/00; B33Y 40/00

(52) U.S. Cl. CPC B22F 12/60; B22F 10/38; B33Y 10/00; B33Y 30/00; B33Y 40/00

(57) ABSTRACT

A metal processing and forming system and a metal processing and forming method for forming a workpiece on a workbench are provided. The system includes a forming device, a shaping device, and a control device. The forming device is configured for providing a metallic material according to a processing path and forming an initial melt of the metallic material. The shaping device is configured for shaping the initial melt. The control device is coupled to the forming device and the shaping device and configured for synchronously controlling the forming device and the shaping device. The control device controls the shaping device to shape the initial melt, before the initial melt is solidified, to form the workpiece.

This application claims the benefit of Taiwan application Serial No. 113100126, filed Jan. 2, 2024, the disclosure of which is incorporated by reference herein in its entirety.

### TECHNICAL FIELD

The disclosure relates to a metal processing and forming system and a metal processing and forming method.

### BACKGROUND

Generally, after the initial manufacturing of a workpiece, it is often necessary to perform post-processing steps in order to achieve the quality required for the workpiece (such as surface roughness, appearance or mechanical properties). If the size of the workpiece is large or the quality requirement of the workpiece is high, it takes a lot of time for post-processing, which causing a long cycle time of the production of the workpiece.

Thus, there is a need for a metal processing and forming system and a metal processing and forming method to solve the problem of long production cycle times while achieving the same quality.

### SUMMARY

The disclosure is directed to a metal processing and forming system and a metal processing and forming method.

According to one embodiment, a metal processing and forming system for forming a workpiece on a workbench is provided. The metal processing and forming system includes a forming device, a shaping device, and a control device. The forming device is configured for providing a metallic material according to a processing path and forming an initial melt of the metallic material. The shaping device is configured for shaping the initial melt. The control device is coupled to the forming device and the shaping device and configured for synchronously controlling the forming device and the shaping device. The control device controls the shaping device to shape the initial melt, before the initial melt is solidified, to form the workpiece.

According to another embodiment, a metal processing and forming method for forming a workpiece on a workbench is provided. The metal processing and forming method includes the following steps: controlling a forming device by a control device to provide a metallic material according to a processing path to form an initial melt of the metallic material; and synchronously controlling a shaping device by the control device such that the shaping device shapes the initial melt, before the initial melt is solidified, to form the workpiece.

### BRIEF DESCRIPTION OF THE DRAWINGS

FIG. 1 is a block diagram of a metal processing and forming system according to one embodiment of the present disclosure.

FIG. 2 is a schematic diagram of the metal processing and forming system according to one embodiment of the present disclosure.

FIG. 3 is a schematic diagram illustrating synchronously forming the initial melt and shaping the initial melt according to one embodiment of the present disclosure.

FIG. 4 is a schematic diagram of the metal processing and forming system according to another embodiment of the present disclosure.

FIG. 5 is a flowchart of a metal processing and forming method according to one embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In the present disclosure, the production cycle time of a workpiece may be reduced by synchronously forming an initial melt and shaping the initial melt.

Each embodiment of the present disclosure will be described in detail below and illustrated with drawings. In addition to these detailed descriptions, the present disclosure may be broadly implemented in other embodiments, and easy substitutions, modifications, and equivalent variations of any of the described embodiments are encompassed within the scope of the present disclosure, and subject to the scope of the patent thereafter. In the description of the specification, many specific details and examples of embodiments are provided in order to provide the reader with a more complete understanding of the present disclosure; however, these specific details and examples of embodiments should not be considered as limitations of the present disclosure. In addition, well-known steps or components are not described in detail to avoid unnecessarily limiting the disclosure.

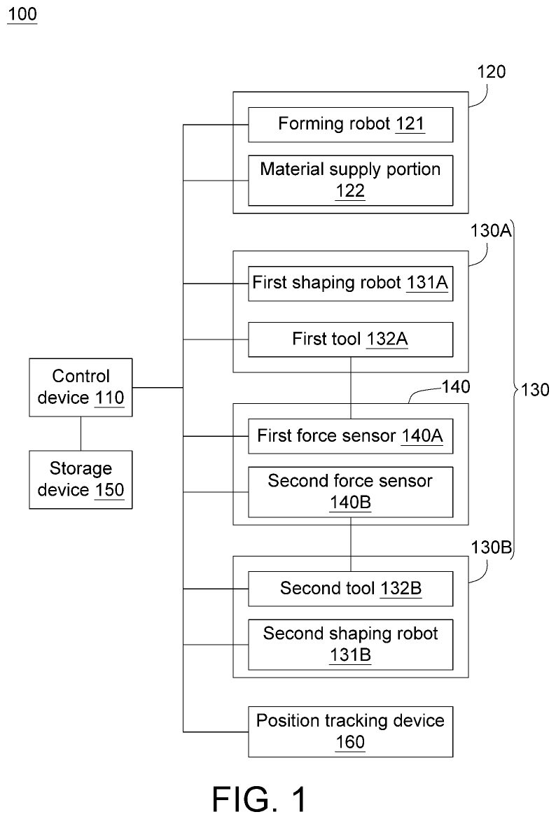

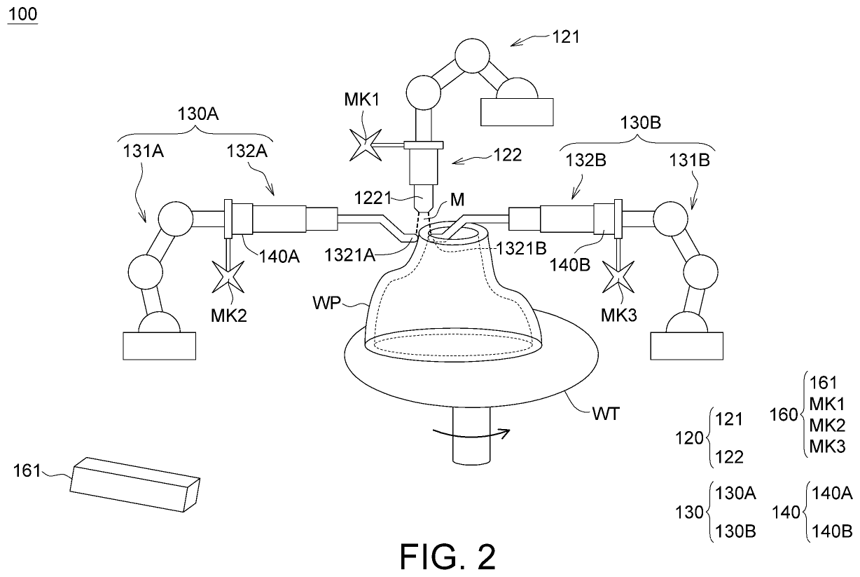

FIG. 1 is a block diagram of a metal processing and forming system 100 according to one embodiment of the present disclosure; FIG. 2 is a schematic diagram of the metal processing and forming system 100 according to one embodiment of the present disclosure.

Referring to FIG. 1 and FIG. 2, the metal processing and forming system 100 is configured for forming a workpiece WP on a workbench WT. The metal processing and forming system 100 includes a control device 110, a forming device 120, a shaping device 130, a force sensing module 140, a storage device 150, and a position tracking device 160. The control device 110 may control the rotation of the workbench WT, and be coupled to the forming device 120 and the shaping device 130. The forming device 120 is configured for supplying material. The shaping device 130 is configured for shaping the material, and is coupled to the force sensing module 140. The storage device 150 is coupled to the control device 110. The position tracking device 160 is coupled to the control device 110, and is configured for tracking a position information of the forming device 120 and the shaping device 130.

The forming device 120 may include a forming robot 121 and a material supply portion 122. The forming robot 121 may be a multi-link robot, such as a six-axis robotic arm. The material supply portion 122 is mounted on a mounting surface of the forming robot 121. The material supply portion 122 may include a material supply head 1221. In one embodiment, the material supply head 1221 may be, but not limited to a Laser Metal Deposition (LMD) head.

The shaping device 130 includes a first shaping module 130A and a second shaping module 130B. The first shaping module 130A may include a first shaping robot 131A and a first tool 132A. The second shaping module 130B may include a second shaping robot 131B and a second tool 132B. The first shaping robot 131A and the second shaping robot 131B may be multi-link robots, such as six-axis robot arms. The first tool 132A and the second tool 132B are mounted on mounting surfaces of the first shaping robot 131A and the second shaping robot 131B, respectively. The first tool 132A and the second tool 132B may include a first tool head 1321A and a second tool head 1321B, respectively. The first tool head 1321A and the second tool head 1321B may be any cutting head which may generate vibrations. In one embodiment, the first tool head 1321A and the second tool head 1321B may be, but not limited to ultrasonic heads.

The control device 110 may synchronously control the forming device 120, the first shaping module 130A, and the second shaping module 130B. The control device 110 may be a hardware circuit or software or a combination of hardware and software, such as a code module, a firmware, and a chip. Further, the control device 110 may be coupled to the forming robot 121, the first shaping robot 131A and the second shaping robot 131B, and actuate the forming robot 121, the first shaping robot 131A, and the second shaping robot 131B. For example, the control device 110 may control actuators that actuate the links and/or joints of the forming robot 121, the first shaping robot 131A and the second shaping robot 131B, so that the forming robot 121, the first shaping robot 131A and the second shaping robot 131B drive the material supply portion 122, the first tool 132A and the second tool 132B respectively disposed on the mounting surfaces thereof to a predetermined position to supply the material and to shape the material at the same time.

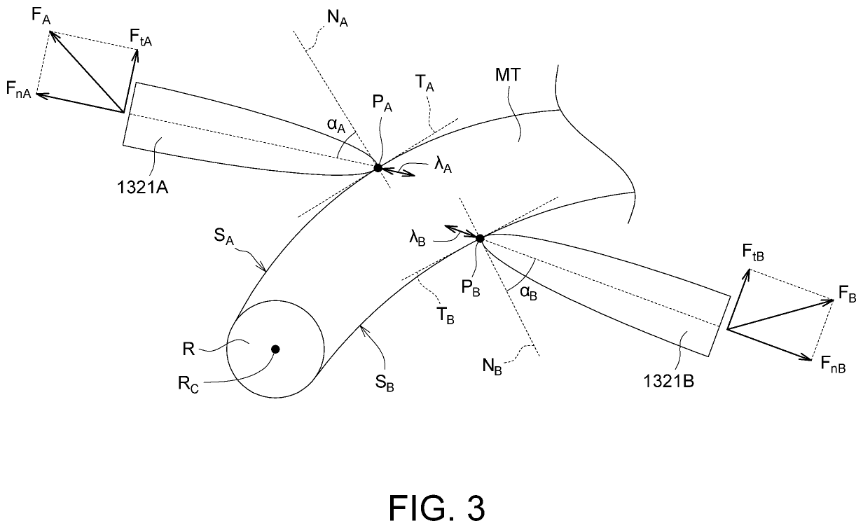

When the workpiece WP is to be fabricated on the workbench WT, a model of the workpiece WP may be input into the control device 110, and the control device 110 may generate instructions for a processing path. The control device 110 may control the forming device 120 to provide a metallic material M according to the processing path. For example, the control device 110 is coupled to the material supply portion 122, and the control device 110 may control the material supply head 1221 to eject the powder of the metallic material M first, and then eject a laser beam (not shown), so that an initial melt MT (as shown in FIG. 3) of the metallic material M may be formed by irradiating the powder of the metallic material M with the laser beam. Before the initial melt MT is completely formed, i.e., before the initial melt MT is solidified by cooling, the control device 110 further controls the first shaping module 130A and the second shaping module 130B to shape the initial melt MT to form the workpiece WP. In other words, the production cycle time of the workpiece WP is shortened by synchronously forming the initial melt MT and shaping the initial melt MT.

FIG. 3 is a schematic diagram illustrating synchronously forming the initial melt MT and shaping the initial melt MT according to one embodiment of the present disclosure. Referring to FIG. 1, FIG. 2 and FIG. 3, the first shaping module 130A and the second shaping module 130B may shape the initial melt MT in a contact manner. In addition, the first shaping module 130A and the second shaping module 130B may shape the initial melt MT on opposite sides of the initial melt MT, respectively. For example, the control device 110 is coupled to the first tool 132A and the second tool 132B, and the control device 110 may emit an operation signal to control the first tool 132A and the second tool 132B, so that the first tool head 1321A and the second tool head 1321B may, in accordance with the operation signal, respectively generate a vibration λ_{A} and a vibration λ_{B} on the surface S_{A} (e.g., the outer surface of the workpiece WP) and the surface S_{B} (e.g., the inner surface of the workpiece WP) of the initial melt MT. The amplitudes of the vibration λ_{A} and the vibration λ_{B} may be determined by the operation signal. But the present disclosure does not limit thereto. In other embodiments, the positions of the first shaping module 130A and the second shaping module 130B may be exchanged. For example, the first tool head 1321A corresponds to the surface S_{B} of the initial melt MT (e.g., the inner surface of the workpiece WP), and the second tool head 1321B corresponds to the surface S_{A} of the initial melt MT (e.g., the outer surface of the workpiece WP).

As shown in FIG. 2 and FIG. 3, the material supply head 1221 continuously supplies material and emits the laser beam along the processing path, and a deposition region R of the metallic material M may be formed under the outlet of the material supply head 1221. The first tool head 1321A may shape the initial melt MT at a first processing position P_{A} on the surface S_{A} of the initial melt MT, and the second tool head 1321B may shape the initial melt MT at a second processing position P_{B} on the surface S_{B} of the initial melt MT. The control device 110 may control the distance of the first processing position P_{A} and the second processing position P_{B} from the deposition region R to remain within a certain range, and the control device 110 may perform the control according to the powder material of the metallic material M, the amount of powder, the power level of the laser beam, the material of the first tool 132A and the second tool 132B, and so forth, for adjusting, for example, the distance between the first processing position P_{A} and a center point R_{C} of the deposition region R, and the distance between the second processing position P_{B} and the center point R_{C} of the deposition region R, so that the first shaping module 130A and the second shaping module 130B shape the initial melt MT before the initial melt MT is solidified. Furthermore, damage to the first tool 132A and the second tool 132B caused by the hard surface of the initial melt MT after solidified may be prevented. In addition, melt of the first tool 132A and the second tool 132B by the high temperature of the laser beam due to the proximity of the laser beam may also be avoided.

In addition, the control device 110 may further adjust a tilt angle as of the first tool head 1321A relative to the surface S_{A} of the initial melt MT so that the vibration λ_{A} is divided into a normal vibration in a normal direction N_{A} relative to the surface S_{A} and a tangent vibration in a tangent direction T_{A} relative to the surface S_{A}. The control device 110 may further adjust a tilt angle as of the second tool head 1321B relative to the surface S_{B} of the initial melt MT so that the vibration A_{B} is divided into a normal vibration in a normal direction N_{B} relative to the surface S_{B} and a tangent vibration in a tangent direction T_{B} relative to the surface S_{B}. When the surfaces S_{A} and S_{B} of the initial melt MT are subjected to the vibration forces in the normal direction N_{A} and N_{B}, the grain size of the metal of the initial melt MT may be further minimized, more grain boundaries may be generated, and the effect of metal forging may be achieved to enhance the overall mechanical strength of the workpiece WP. When the surfaces S_{A} and S_{B} of the initial melt MT are subjected to the vibration forces in the tangent direction T_{A} and T_{B}, it is possible to trim the surfaces S_{A} and S_{B} and reduce the surface roughness of the workpiece WP. Therefore, by generating the normal vibrations in the normal direction N_{A} and N_{B} and the tangent vibrations in the tangent direction T_{A} and T_{B} on the surfaces S_{A} and S_{B}, it is possible to strengthen the mechanical strength of the workpiece WP and improve the surface roughness of the workpiece WP at the same time.

Referring to FIG. 1, FIG. 2 and FIG. 3, in the present embodiment, the force sensing module 140 includes a first force sensor 140A and a second force sensor 140B. The first force sensor 140A is coupled to the first tool 132A and configured for sensing a force value F_{A} of the first tool head 1321A during the shaping process of the initial melt MT. The second force sensor 140B is coupled to the second tool 132B and configured for sensing a force value F_{B} of the second tool head 1321B during the shaping process of the initial melt MT. Herein, the control device 110 is coupled to the first force sensor 140A and the second force sensor 140B, and the control device 110 may further adjust the tilt angles da and as of the first tool head 1321A and the second tool head 1321B according to the force values F_{A} and F_{B} sensed by the first force sensor 140A and the second force sensor 140B, so as to obtain the desired mechanical strength and surface roughness of the workpiece WP.

In the present embodiment, the storage device 150 may store a plurality of parameter sets that may be associated with material properties of different workpieces, material properties such as, but not limited to, mechanical properties, surface roughness, and the like. Each parameter set may be associated with the material properties of a workpiece. The parameter sets record the relationship between the force values and the tilt angles, such as the relationship between the normal direction force F_{nA}, the tangent direction force F_{tA} and the tilt angle α_{A}, and the relationship between the normal direction force F_{nB}, the tangent direction force F_{tB} and the tilt angle α_{B}. The control device 110 may read, from the storage device 150, a suitable parameter set, i.e., a parameter set associated with the material properties of the workpiece WP to be produced, and adjust the tilt angles α_{A} and α_{B} of the first tool head 1321A and the second tool head 1321B according to the sensed force values F_{A} and F_{B} based on the parameter set.

In addition, in the present embodiment, the position tracking device 160 may include an optical sensor 161, a first marker MK1, a second marker MK2, and a third marker MK3. The first marker MK1, the second marker MK2, and the third marker MK3 may be disposed on the mounting surfaces of the forming robot 121, the first shaping robot 131A and the second shaping robot 131B, respectively. The first marker MK1, the second marker MK2 and the third marker MK3 may reflect light of a wavelength that may be captured by the optical sensor 161, so that the optical sensor 161 may track the positions of the first marker MK1, the second marker MK2 and the third marker MK3 to obtain positional information for the forming device 120, the first shaping module 130A and the second shaping module 130B, and then provide the tracked positional information of the forming device 120, the first shaping module 130A and the second shaping module 130B to the control device 110. The control device 110 may obtain the material supply position of the material supply head 1221 of the forming device 120, the first processing position P_{A} of the first tool head 1321A of the first shaping module 130A and the second processing position P_{B} of the second tool head 1321B of the second shaping module 130B according to the position information and through a coordinate conversion relationship. Once the control device 110 determines that there is a deviation from the material supply position, the first processing position P_{A} and the second processing position P_{B}, the control device 110 may immediately correct the positions.

In addition, the present disclosure does not limit the number of shaping devices, but the number of shaping devices may be set up depending on the material, type, shape, and so on of the workpieces to be fabricated.

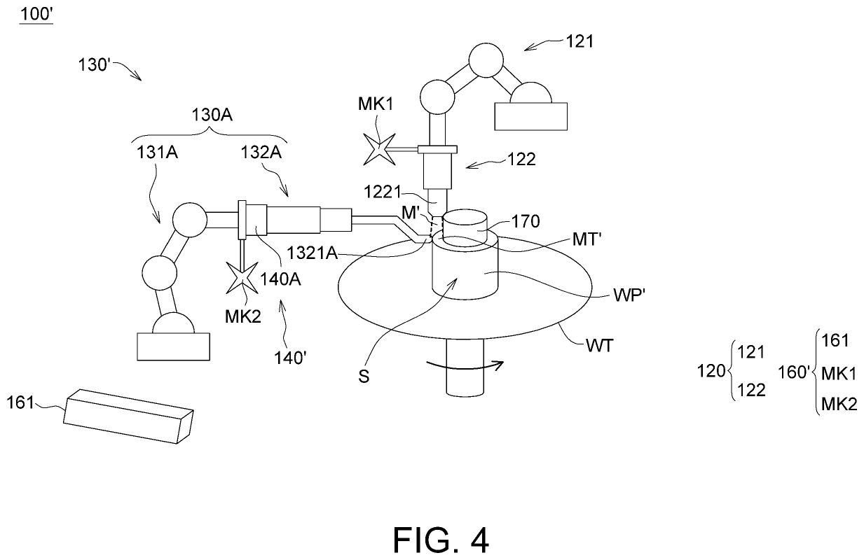

FIG. 4 is a schematic diagram of the metal processing and forming system 100′ according to another embodiment of the present disclosure. Referring to FIG. 4, the metal processing and forming system 100′ is configured for forming a workpiece WP′, which has a column structure 170 located in the center of the workpiece WP′, on a workbench WT. One difference from the embodiment of FIG. 2 is that the shaping device 130′ of the metal processing and forming system 100′ includes only a first shaping module 130A (i.e., there is only one shaping module). The following is particularly focused on the differences from the embodiment of FIG. 2, while other similarities or analogies will not be repeated.

The forming device 120 may provide an initial melt MT′ of a metallic material M′ along the outer surface of the column structure 170. Similar to the above mentioned embodiment, before the initial melt MT′ is solidified by cooling, the control device 110 may synchronously control the shaping device 130′ to shape the initial melt to form the workpiece WP′. In other words, the production cycle time of the workpiece WP′ is shortened by synchronously forming the initial melt MT′ and shaping the initial melt MT′.

The force sensing module 140′ includes only a first force sensor 140A, which is also coupled to the first tool 132A and configured for sensing the force value of the first tool head 1321A during the shaping process of the initial melt MT′. The control device 110 may further adjust the tilt angle of the first tool head 1321A according to the force value sensed by the first force sensor 140A, in order to obtain the desired mechanical strength and surface roughness of the workpiece WP′.

In the present embodiment, the position tracking device 160′ of the metal processing and forming system 100′ includes only an optical sensor 161, a first marker MK1 and a second marker MK2 (i.e., the third marker MK3 is omitted), and is configured for tracking the position information of the forming device 120 and the first shaping module 130A. The control device 110 may also obtain the material supply position of the material supply head 1221 of the forming device 120 and the first processing position of the first tool head 1321A of the first shaping module 130A according to the position information and through a coordinate conversion relationship. Once the control device 110 determines that there is a deviation between the material supply position and the first processing position, the control device 110 may immediately correct the positions.

Since only one surface S of the workpiece WP′ is required to be processed and formed in the present embodiment, e.g., only its outer surface is required to be processed, the shaping device 130′ of the metal processing and forming system 100′ may also include only a second shaping module 130B (i.e., the first shaping module 130A is omitted and there is only one shaping module).

In view of the above, the present disclosure does not limit the number of shaping modules included in the shaping devices 130, 130′ of the metal processing and forming systems 100, 100′, which may be set up according to the shape or style of the workpiece to be fabricated/processed.

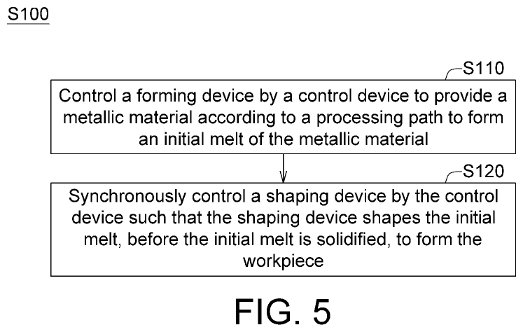

FIG. 5 is a flowchart of a metal processing and forming method S100 according to one embodiment of the present disclosure. Referring to FIG. 5, the metal processing and forming method S100 is applicable to fabricate the workpiece WP in the embodiment of FIG. 2 and the workpiece WP′ in the embodiment of FIG. 4, and includes the following steps. In step S110, a forming device is controlled by a control device to provide a metallic material according to a processing path to form an initial melt of the metallic material. In step S120, a shaping device is synchronously controlled by the control device such that the shaping device shapes the initial melt, before the initial melt is solidified, to form the workpiece.

In summary, the metal processing and forming system and the metal processing and forming method provided according to the present disclosure shorten the production cycle time of the workpiece by synchronously forming the initial melt and shaping the initial melt. In some embodiments, the control device may further adjust the tilt angle of the tool head relative to the surface of the initial melt such that the vibration is divided into the normal vibration in the normal direction relative to the surface and the tangent vibration in the tangent direction relative to the surface, so as to reinforce the mechanical strength of the workpiece and improve the surface roughness of the workpiece. In some embodiments, the control device may further adjust the tilt angle of the tool head according to the force value sensed by the force sensor to obtain the desired mechanical strength and surface roughness of the workpiece. In some embodiments, the storage device may store a plurality of parameter sets associated with material properties of different workpieces. The control device may read a suitable parameter set from the storage device and adjust the tilt angle of the tool head according to the sensed force values based on the parameter set.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A metal processing and forming system for forming a workpiece on a workbench, the metal processing and forming system comprising:
a forming device configured for providing a metallic material according to a processing path and forming an initial melt of the metallic material;
a shaping device configured for shaping the initial melt; and
a control device coupled to the forming device and the shaping device, and configured for synchronously controlling the forming device and the shaping device;
wherein the control device controls the shaping device to shape the initial melt, before the initial melt is solidified, to form the workpiece.

2. The metal processing and forming system according to claim 1, wherein the shaping device comprises a first tool head, and the first tool head generates a vibration on a surface of the initial melt.

3. The metal processing and forming system according to claim 2, wherein the control device adjusts a tilt angle of the first tool head relative to the surface such that the vibration comprises a normal vibration in a normal direction relative to the surface and a tangent vibration in a tangent direction relative to the surface.

4. The metal processing and forming system according to claim 3, further comprising a force sensing module coupled to the first tool head and the control device, and configured for sensing a force value of the first tool head during shaping the initial melt;
wherein the control device adjusts the tilt angle of the first tool head according to the force value.

5. The metal processing and forming system according to claim 4, further comprising a storage device coupled to the control device and configured for storing a plurality of parameter sets associated with material properties of different workpieces;
wherein the control device adjusts the tilt angle of the first tool head according to the force value by a parameter set of the parameter sets associated with the material property of the workpiece.

6. The metal processing and forming system according to claim 1, further comprising a position tracking device coupled to the control device and configured for tracking a position information of the forming device and the shaping device;
wherein the control device corrects positions of the forming device and the shaping device in real time according to the position information tracked by the position tracking device.

7. The metal processing and forming system according to claim 1, wherein the forming device comprises a material supply head, the forming device forms a deposition region of the metallic material below an outlet of the material supply head, the shaping device shapes the initial melt at a first processing position of the initial melt, and the control device controls a distance of the first processing position from the deposition region such that the shaping device shapes the initial melt prior to solidification of the initial melt.

8. The metal processing and forming system according to claim 2, wherein the first tool head is an ultrasonic head.

9. The metal processing and forming system according to claim 1, wherein the shaping device shapes the initial melt in a contact manner.

10. The metal processing and forming system according to claim 2, wherein the shaping device comprises a first shaping module and a second shaping module, the first shaping module comprises the first tool head, the second shaping module comprises a second tool head, and the first tool head and the second tool head respectively shape the initial melt on opposite sides of the initial melt.

11. A metal processing and forming method for forming a workpiece on a workbench, the metal processing and forming method comprising:
controlling a forming device by a control device to provide a metallic material according to a processing path to form an initial melt of the metallic material; and
synchronously controlling a shaping device by the control device such that the shaping device shapes the initial melt, before the initial melt is solidified, to form the workpiece.

12. The metal processing and forming method according to claim 11, wherein the shaping device comprises a first tool head, and the first tool head generates a vibration on a surface of the initial melt.

13. The metal processing and forming method according to claim 12, wherein the step of synchronously controlling the shaping device by the control device further comprising:
adjusting a tilt angle of the first tool head relative to the surface by the control device such that the vibration comprises a normal vibration in a normal direction relative to the surface and a tangent vibration in a tangent direction relative to the surface.

14. The metal processing and forming method according to claim 13, further comprising:
sensing a force value of the first tool head by a force sensing module during shaping the initial melt;
wherein the control device adjusts the tilt angle of the first tool head according to the force value.

15. The metal processing and forming method according to claim 14, further comprising:
storing a plurality of parameter sets by a storage device, the parameter sets associated with material properties of different workpieces;
wherein the control device adjusts the tilt angle of the first tool head according to the force value by a parameter set of the parameter sets associated with the material property of the workpiece.

16. The metal processing and forming method according to claim 11, further comprising:
tracking a position information of the forming device and the shaping device by a position tracking device;
wherein the control device corrects positions of the forming device and the shaping device in real time according to the position information tracked by the position tracking device.

17. The metal processing and forming method according to claim 11, wherein the forming device comprises a material supply head, the forming device forms a deposition region of the metallic material below an outlet of the material supply head, the shaping device shapes the initial melt at a first processing position of the initial melt, and the metal processing and forming method further comprises:
controlling a distance of the first processing position from the deposition region by the control device such that the shaping device shapes the initial melt prior to solidification of the initial melt.

18. The metal processing and forming method according to claim 12, wherein the first tool head is an ultrasonic head.

19. The metal processing and forming method according to claim 11, wherein the shaping device shapes the initial melt in a contact manner.

20. The metal processing and forming method according to claim 12, wherein the shaping device comprises a first shaping module and a second shaping module, the first shaping module comprises the first tool head, the second shaping module comprises a second tool head, and the first tool head and the second tool head respectively shape the initial melt on opposite sides of the initial melt.
